(19) United States
(12) Patent Application Publication
(10) Pub. No.: US 2025/0310454 A1
(43) Pub. Date: Oct. 2, 2025

(54) STORAGE MEDIUM, METHOD, AND INFORMATION PROCESSING APPARATUS

(71) Applicant: CANON KABUSHIKI KAISHA, Tokyo (JP)

(72) Inventor: YASUHIRO TAKAHASHI, Chiba (JP)

(21) Appl. No.: 19/088,462

(22) Filed: Mar. 24, 2025

(30) Foreign Application Priority Data
Mar. 27, 2024 (JP) 2024-052421

(51) Int. Cl. H04N 1/00

(52) U.S. Cl. CPC H04N 1/00811; H04N 1/00413; H04N 1/00482; H04N 1/00689; H04N 1/00692; H04N 1/00694

(57) ABSTRACT

A computer-readable storage medium that stores a program for supporting general-purpose scanning software that is commonly available for use with a plurality of image processing devices, the program causing an information processing apparatus to execute a method that comprises displaying a screen on a display of the information processing apparatus, the screen is used to set either a platen or a feeder as a placement location for a document to be scanned, and transmitting an instruction to scan the document to an image processing device based on the placement location specified on the screen.

### BACKGROUND

### Field

The present disclosure relates to a storage medium, a method, and an information processing apparatus.

### Description of the Related Art

There is a known configuration of control software for scanning devices in which scan instructions are provided to the scanning device connected to a host computer using a scan driver installed in the host computer. An operating system (hereinafter referred to as “OS”), which serves as the basic software, is installed in the host computer. The scan driver is configured according to the specifications defined by the OS and operates when involved by the OS.

The vendor that provides the scanning device can provide a means for instructing the scanning device to scan using the OS by providing a scan driver conforming to the specifications of the OS.

Windows® has recently provided a standard class driver (hereinafter also referred to as “standard driver”) that can be commonly used with scanning devices provided by multiple vendors. Such a standard driver is packed in the OS package and can easily be used by connecting any scanning device to the host computer. This eliminates the need for separately installing a device-specific scan driver suitable for the scanning device, which enhances the convenience. The standard driver may be configured to allow scanning functions to be specified based on scanning function information generated from data obtained from the connected scanning device. This enables users of the standard driver to specify scanning functions according to the capabilities of the connected scanning device, even though they are using a single standard driver. However, this is limited to functions that can be implemented only by the standard driver, and therefore, it is not possible to specify functions unique to the scanner manufacturer.

Japanese Patent Laid-Open No. 2021-033526 discloses a program for extending the printing function of general-purpose software.

One example of the functions unique to the scanner manufacturer is a document scan source specification function. The document scan source specification function is a function that allows the specification of the placement location of the document on the scanning device according to its capabilities. A generally known placement location of the document is a platen on which the documents are scanned one by one. Some recent scanning devices are equipped with a feeder which is configured to allow continuous scanning of multiple documents using an automatic document feeder. The user can scan the document from the placement location of the document by specifying the document scanning scan source, thereby obtaining image data.

However, the standard driver, which is general-purpose scanning software, does not support the document scan source specification function. For this reason, in a scanning device in which both the platen and the feeder can be used, there may be cases where the user is unable to correctly scan documents and obtain image data from the location where the documents are placed.

### SUMMARY

The present disclosure provides a computer-readable storage medium that stores a program for supporting general-purpose scanning software that is commonly available for use with a plurality of image processing devices, the program causing an information processing apparatus to execute a method that comprises displaying a screen on a display of the information processing apparatus, the screen is used to set either a platen or a feeder as a placement location for a document to be scanned, and transmitting an instruction to scan the document to an image processing device based on the placement location specified on the screen.

Further features of the present disclosure will become apparent from the following description of exemplary embodiments with reference to the attached drawings.

### BRIEF DESCRIPTION OF THE DRAWINGS

FIG. 1 is a block diagram illustrating the hardware configuration of an entire system according to an embodiment of the present disclosure.

FIG. 2A is a diagram illustrating a general configuration of the software of a system according to an embodiment.

FIG. 2B is a diagram illustrating the configuration of the software of a system according to an embodiment.

FIGS. 3A to 3C are diagrams illustrating scan-settings advanced-settings screens according to a first embodiment.

FIG. 4 is a flowchart illustrating the operations of a scan application, general-purpose scanning software, and an extension application according to the first embodiment.

FIG. 5 illustrates the capability of the scanning apparatus, the general-purpose scanning software, the extension application according to the first embodiment in tabular form.

FIGS. 6A and 6B illustrate a sequence chart of the operation of the entire system according to the first embodiment.

FIG. 7 is a flowchart illustrating the operation of the extension application according to the first embodiment.

FIG. 8 is a flowchart illustrating the operation of the scanning device according to the first embodiment.

FIG. 9 is a flowchart illustrating the rotation process of the scanning device according to the first embodiment.

FIGS. 10A and 10B are diagrams illustrating the operation of the image processing unit of the scanning device according to the first embodiment.

FIGS. 11A to 11C are diagrams illustrating the operation of the image processing unit of the scanning device according to the first embodiment.

FIGS. 12A to 12C are diagrams illustrating the operation of the image processing unit of the scanning device according to the first embodiment.

FIGS. 13A to 13C are diagrams illustrating advanced-settings screens displayed by the extension application according to the first embodiment.

FIGS. 14A and 14B illustrate a sequence chart of the operation of an entire system according to a second embodiment.

FIG. 15 is a diagram illustrating an advanced-settings screen displayed by the extension application according to the second embodiment.

FIG. 16A and 16B illustrate a flowchart for the operation of the extension application according to the second embodiment.

FIG. 17 is a diagram illustrating an advanced-settings screen displayed by the extension application according to the second embodiment.

### DESCRIPTION OF THE EMBODIMENTS

Embodiments of the present disclosure will be described hereinbelow with reference to the accompanying drawings. It is to be understood that the following embodiments do not limit the present disclosure according to the claims and that not all of the combinations described in the embodiments are required for the solution of the present disclosure.

### First Embodiment

### Hardware Configuration of Scanning System

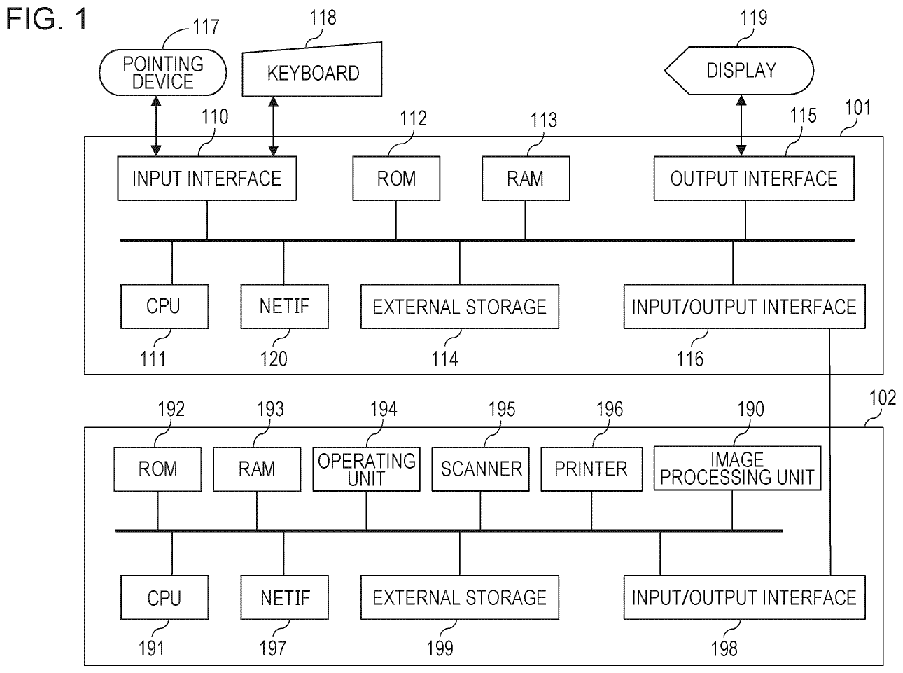

FIG. 1 is a block diagram illustrating the hardware configuration of a scanning system.

A host computer 101 is an example of an information processing apparatus, which includes an input interface 110, a central processing unit (CPU) 111, a read only memory (ROM) 112, a random-access memory (RAM) 113, an external storage 114, an output interface 115, and an input/output interface 116. The input interface 110 connects to input devices including a keyboard 118 and a pointing device 117. The output interface 115 connects to a display device such as a display 119. A network interface (NETIF) 120 performs control for transferring data to/from an external device via a network. The ROM 112 stores initialization programs.

Examples of the external storage 114 include a hard disk drive (HDD) and a solid-state drive (SSD). The external storage 114 stores application programs, an operating system (OS), and various items of data.

The RAM 113 is used as a work memory or the like in executing various programs stored in the external storage 114 to allow the various programs to operate in the host computer 101.

In this embodiment, the CPU 111 performs processes according to the codes of the computer-executable programs stored in the ROM 112 to execute the functions of the host computer 101 and the processes of the flowcharts, described below.

The scanning device 102 is an example of an image reading device. An input/output interface 198 of the scanning device 102 is connected to the host computer 101 via the input/output interface 116 of the host computer 101. The input/output interface 198 of the scanning device 102 and the input/output interface 116 of the host computer 101 may be connected via a wired or wireless network.

The scanning device 102, which is an image reading device, includes a CPU 191, a ROM 192, a RAM 193, an operating unit 194, a scanner 195, a printer 196, a NETIF 197, and an input/output interface 198.

The CPU 191 control the scanning device 102 as a whole. The ROM 192 is a memory that stores programs that are executable by the CPU 191.

The RAM 193 is a memory that temporarily stores the codes of the programs and image data.

The scanner 195 includes a platen and a feeder, and it reads images of documents. The platen supports scanning only one document at a time, while the feeder supports continuously feeding and scanning multiple documents. The feeder also supports continuously scanning the back side by reversing the document that is read once and feeding it.

The printer 196 prints images on sheets based on image data. The printer 196 is not an absolute necessity.

The NETIF 197 is a network interface that performs control for data transfer to/from an external device. The image processing unit 190 performs various image editing processes on the input image data.

Here, the host computer 101 and the scanning device 102, which is an image reading device, are separately configured, but they may be configured as a single information processing apparatus. The scanning settings screen and the advanced-settings screen, described below, are displayed on the display 119. In this embodiment, the scanning device, which is an image reading device, will be described using an electrophotographic digital multifunction device having multiple functions, such as copying, printing, and faxing, as an example. Therefore, the scanning device 102 can also be considered as an example of an image processing device. This embodiment is also applicable to devices that use an ink-jet method or other processes and scanners that read only images. The host computer 101 may be a desktop personal computer, a smartphone, or a notebook personal computer.

### Software Configuration of Scanning System

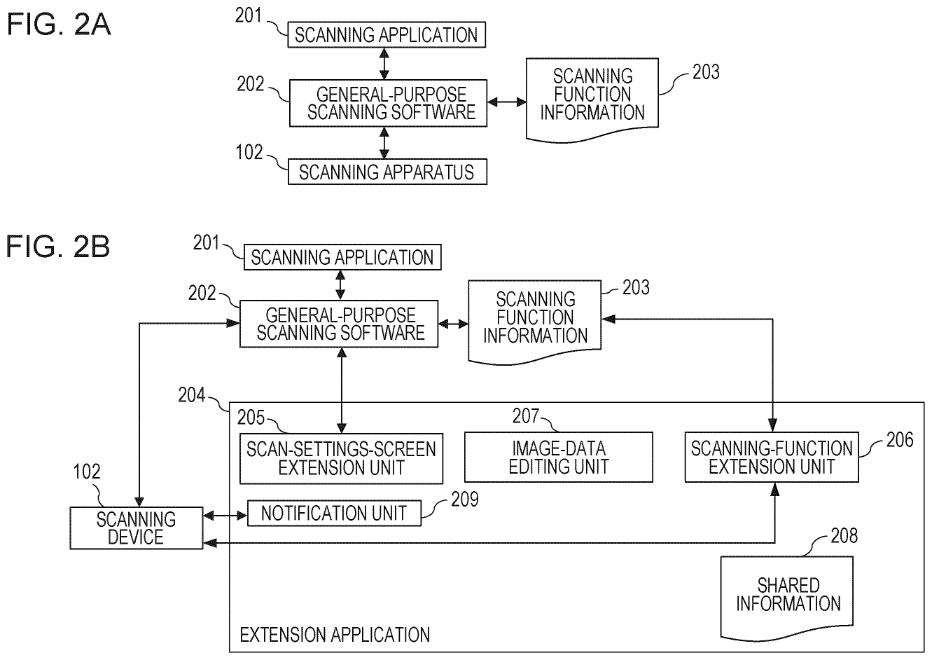

FIGS. 2A and 2B are schematic diagrams illustrating the software configuration of the scanning system. The software configuration in FIGS. 2A and 2B is stored in the external storage 114 of FIG. 1. Here, the explanation is based on a scanning system that uses the host computer 101 equipped with Microsoft® Windows® 11 as its OS. However, the version of Windows® is not limited to 11 and may be any version to which the present disclosure can be applied.

FIG. 2A is a diagram illustrating a general configuration in which an extension application 204 is not associated with general-purpose scanning software 202 and the scanning device 102.

FIG. 2B is a diagram illustrating a configuration in which the extension application 204 is associated with the general-purpose scanning software 202 and the scanning device 102.

### Without Extension Application

First, the configuration of the scanning system in the case where the extension application 204 is not associated will be described with reference to FIG. 2A.

The scan application 201 is software for importing scanned content (image data). Examples include a document creation application and an image editing application. In response to receiving a scan request from the user, the scan application 201 issues scan instructions to the OS. The scan instructions include scan settings information to specify the operations of the general-purpose scanning software 202 and the scanning device 102.

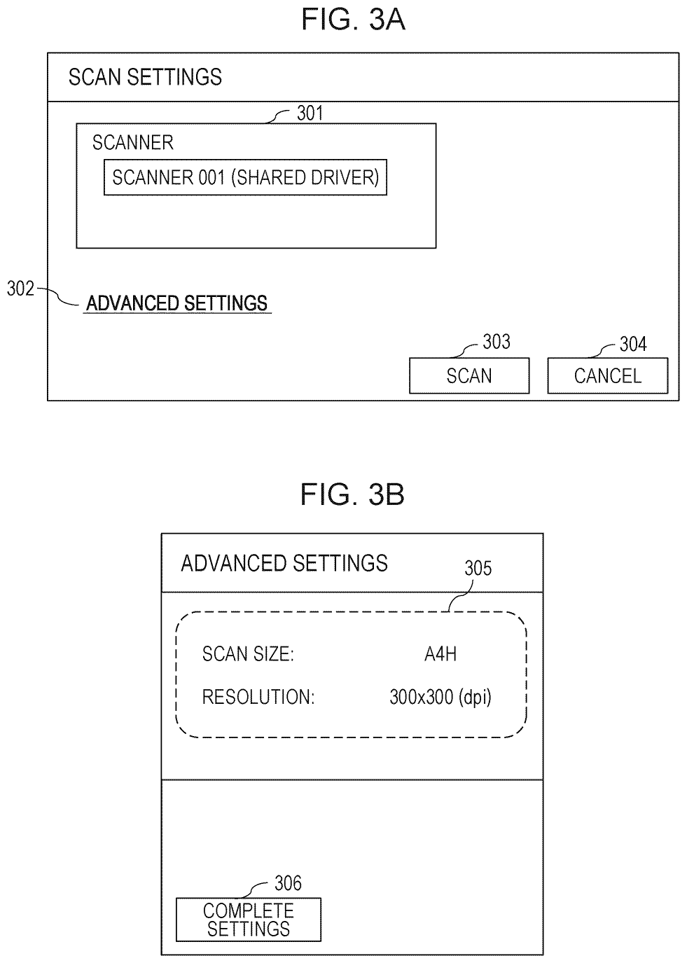

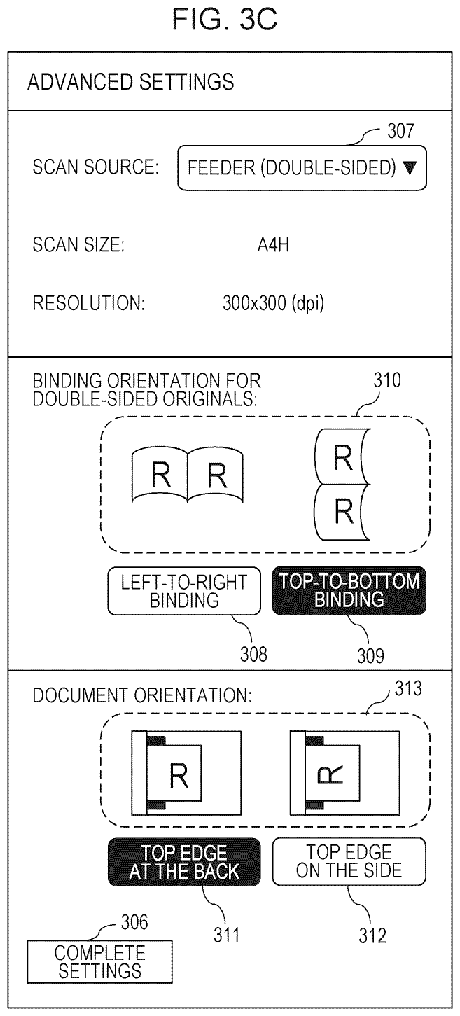

The scan application 201 can display a scan-settings screen provided by the general-purpose scanning software 202, the OS, or the scan application 201 to execute the scan instructions. When “advanced settings” in the scan-settings screen is pressed, the general-purpose scanning software 202 additionally displays an advanced-settings screen. The scan-settings screen and the advanced-settings screen will be described below with reference to FIGS. 3A to 3C. The advanced-settings screen includes setting items indicating configurable scanning functions (hereinafter also referred to as “control items”) and control items indicating their setting values according to the capability information (configurable information) from the general-purpose scanning software 202.

The general-purpose scanning software 202 is provided by the provider of the OS and is packed in the same package as the OS. The general-purpose scanning software 202 determines the scan capability based on scanning function information 203. The scanning function information 203 is data that indicates all configurable scanning functions, their setting values, and the exclusion relationship among the setting values. The scanning function information 203 is included in the configuration file of the general-purpose scanning software 202 and is placed in the external storage 114 as an unchangeable file.

Alternatively, the scanning function information 203 may be dynamically generated by the general-purpose scanning software 202. Specifically, the general-purpose scanning software 202 or the OS may be configured to obtain the attribute data of the scanning device from the scanning device 102 and generate the scanning function information 203 according to the attribute information in the obtained attribute data. The scanning function information 203, if dynamically generated, can be edited. The attribute data of the scanning device obtained from the scanning device 102 includes attribute information indicating functions that can be specified by the scanning device 102 (the capability of the scanning device 102) and setting values related to the attribute information. This information is stored in the RAM 113.

This configuration of the general-purpose scanning software 202 allows the user to specify scanning functions commonly available across all the scanning devices 102 according to the connected scanning device 102. In other words, even if a scanning device with different functions or a scanning device developed by a different vendor is connected, the general-purpose scanning software 202 allows the user to specify commonly available scanning functions according to the connected scanning device. The vendor may be translated into the manufacture of the scanning device 102. Here, the general-purpose scanning software 202 is a standard-class driver for executing scanning operations based on a standard scan protocol called Mopria.

The general-purpose scanning software 202 obtains the capability information of the connected scanning device 102 so that the user can specify scanning functions supported by the connected scanning device 102 and generates the scanning function information 203 based on the information. However, the general-purpose scanning software 202 does not support a document scan source specification function. This is because the document scan source specification function is a unique function of the scanner vendor (or the scanner manufacturer).

### With Extension Application

Next, the configuration of the scanning system in the case where the extension application 204 is associated will be described with reference to FIG. 2B. Any configurations and processes not specifically mentioned are of the same configuration as in FIG. 2A.

The extension application 204 is software for extending the functions of the general-purpose scanning software 202 and is not contained (packed) in advance in the OS. For this reason, the user needs to operate the host computer 101 to download the extension application 204 from the server via the Internet and install it. Alternatively, the extension application 204 may be automatically installed in response to connection of the scanning device 102, which is an image reading device, to the host computer 101. Specifically, when the scanning device 102 is connected to the host computer 101, the OS obtains device identification information (hardware ID) from the scanning device 102. The OS may transmit the obtained device identification information to the server via the Internet, download the extension application 204 corresponding to the device identification information from the server, and install it. In other words, the general-purpose scanning software 202 and the extension application 204 are stored in the host computer 101 as different files.

The general-purpose scanning software 202 and the extension application 204 may be updated and version-upgraded, but these update processes are carried out at separate times. In other words, the timing of when the general-purpose scanning software 202 is obtained and the timing of when the extension application 204 by the host computer 101 is obtained are different. The trigger to obtain the general-purpose scanning software 202 and the trigger to obtain the extension application 204 by the host computer 101 are also different. When the extension application 204 is installed, the OS associates the extension application 204 with the general-purpose scanning software 202 and the scanning device 102.

### Extension Application

The extension application 204 described in this embodiment includes a scan-settings-screen extension unit 205, a scanning-function extension unit 206, an image-data editing unit 207, and a notification unit 209. The extension application 204 further includes shared information 208 accessible from each unit. The actual form of the shared information 208 is a file stored in the external storage 114 or information stored on the RAM 113. The extension application 204 writes and reads information to/from the shared information 208 by using an application program interface (API) provided by the OS.

The extension application 204 may terminate the operation every time the process of each unit is completed. In that case, the OS starts the extension application 204 every time a request to use the unit is provided.

Furthermore, the extension application 204 may cancel the process of each unit during the process. If the process is cancelled, the job being processed is deleted by the OS.

In response to receiving a scan request from the user, the scan application 201 issues scan instructions to the OS. Also in this embodiment, the scan application 201 can display a scan-settings screen, as with the configuration of FIG. 2A. In this embodiment, an advanced-settings screen provided by the extension application 204 is displayed. Specifically, an advanced-settings screen provided by the scan-settings-screen extension unit 205 of the extension application 204 is displayed. The scan-settings-screen extension unit 205 can store advanced settings set by the user in the shared information 208.

The image-data editing unit 207 obtains image data from the scanning device 102 and edits the image data. The image-data editing unit 207 obtains advanced settings information from the shared information 208 and edits the image data according to the advanced settings. The extension application 204 may be configured to obtain image data obtained by the general-purpose scanning software 202 and edit the image data according to the advanced settings.

The scanning-function extension unit 206 can edit the scanning function information 203 generated by the general-purpose scanning software 202 or the OS. For this reason, the scanning-function extension unit 206 can add functions provided by the extension application 204. The scanning-function extension unit 206 can also add a function that is supported by the scanning device 102 by is not supported by the general-purpose scanning software 202 (a document scan source specification function), the exclusion relationship among the setting values of the scanning functions, and so on. When the extension application 204 is first associated with the scanning device 102 and the general-purpose scanning software 202, the OS starts the scanning-function extension unit 206. The OS may start the scanning-function extension unit 206 when the OS is started or at another time.

The notification unit 209 can display a notification to the user in response to the occurrence of an error in the scanning device 102. For example, when a scan jam error occurs in the scanning device 102, the general-purpose scanning software 202 detects it, and the OS causes the display 119 to display a message using a notification function called a toast notification, which is a function of the OS. When the toast notification is pressed by the user, the notification unit 209 of the extension application 204 is invoked by the OS, and the user interface (UI) screen of the notification unit 209 is displayed. On the UI screen of the notification unit 209, for example, a scan jam error detailed message or a jam clear method can be displayed.

The configuration of the extension application 204 for implementing this embodiment is not limited to one that includes all of the above-described functions (units) and may include only some of the functions or additional functions. The extension application 204 may also be simply referred to as scanning software. The extension application 204 may include at least one of the following functions. The first is a function to display a scan settings screen (the scan-settings-screen extension unit 205). The second is a function to edit image data according to advanced settings (the image-data editing unit 207). The third is a function to extend functions that can be specified by image data generating software (the scanning-function extension unit 206). The fourth is a function to display a screen in response to the occurrence of an error in the scanning device 102 (the notification unit 209).

### Example of Scan-Settings Screen/Advanced-Settings Screen

Next, examples of the scan-settings screen and the advanced-settings screen of this embodiment will be described with reference to FIGS. 3A to 3C.

FIG. 3A illustrates a scan-settings screen displayed by the scan application 201.

FIG. 3B illustrates an advanced-settings screen displayed in the case of the configuration without the extension application 204, illustrated in FIG. 2A.

FIG. 3C illustrates an advanced-settings screen displayed in the case of the configuration with the extension application 204 illustrated in FIG. 2B.

The units or modules for displaying the scan-settings screen are not limited to those described above. For example, the scan-settings-screen extension unit 205 may be configured only to generate a display screen. In that case, the scan-settings-screen extension unit 205 sends the generated display screen to the scan application 201 via the general-purpose scanning software 202. The scan application 201 may be configured to display the obtained display screen.

### Scan-Settings Screen (Scan Application)

The scan-settings screen displayed by the scan application will be described with reference to FIG. 3A.

A control 301 includes objects for causing the user to set a scanner to be used to scan image data (a scanner to be used for scanning).

A control 302 is an advanced settings button. When the control 302 is pressed, an additional scan screen is displayed by the general-purpose scanning software 202 or the scan-settings-screen extension unit 205.

A control 303 is a scan start button. A control 304 is a scan cancel button.

### Advanced-Settings Screen (General-Purpose Scanning Software)

An advanced-settings screen displayed by the general-purpose scanning software will be described with reference to FIG. 3B.

FIG. 3B is a setting screen displayed by the general-purpose scanning software 202 in the case without the extension application 204. With the general-purpose scanning software 202, there are no items whose settings can be changed, and the items are fixed to scan size: A4H and resolution: 300×300 dpi, as illustrated in a display 305. A control 306 is a settings completion button. When the control 306 is pressed, the screen returns to the scan-settings screen illustrated in FIG. 3A.

### Advanced-Settings Screen (Extension Application)

The advanced-settings screen displayed by the extension application will be described with reference to FIG. 3C.

FIG. 3C is an additional setting screen displayed by the scan-settings-screen extension unit 205 in the configuration with the extension application 204. Unlike FIG. 3B, some setting items are changeable.

A control 307 is a control for specifying a scan source, which is a characteristic setting in this embodiment. The control 307 allows for selecting a platen or a feeder. The feeder includes options: scanning of a single-sided document; and scanning of a double- sided document. The control 307 include three options: platen; feeder (single-sided); and feeder (double-sided).

Controls 308 and 309 are displayed when “feeder (double-sided)” is selected in the control 307, in which left-to-right binding or top-to-bottom binding can be set for binding double-sided originals. A guide 310 is an image of the originals, which serves as a guide for the user.

Controls 311 and 312 are buttons for setting the orientation of a document placed in the feeder. A guide 313 represents the images of the documents placed in the feeder, which serves as a user guide for the orientation of the placed document, corresponding to “top edge at the back” and “top edge on the side”.

FIG. 3C illustrates an example in which the user placed a double-sided original with top-to-bottom binding in the feeder, with the orientation set to “top edge at the back”.

The reason why the scan setting items differ between FIG. 3B and FIG. 3C will be described. The advanced-settings screen is generated with reference to scan capability generated based on the scanning function information 203. However, since the general- purpose scanning software 202 does not support the scan source specification function, the scan source specification function cannot be added to the scanning function information 203. Even if the scanning function information 203 includes the scan source specification function, the general-purpose scanning software 202 cannot interpret the scan source specification function, and therefore, the scan source specification function cannot be displayed on the advanced-settings screen.

However, the scanning-function extension unit 206 can add the scan source specification function to the scanning function information 203, and the scan-settings- screen extension unit 205 can display the advanced-settings screen with reference to the scan capability. The scanning-function extension unit 206 enables the extension application 204 to display the scan source specification function on the advanced-settings screen. FIG. 3C may additionally include extended functions other than the scan source specification function.

### Scanning Function Information Editing Process (Extension Application)

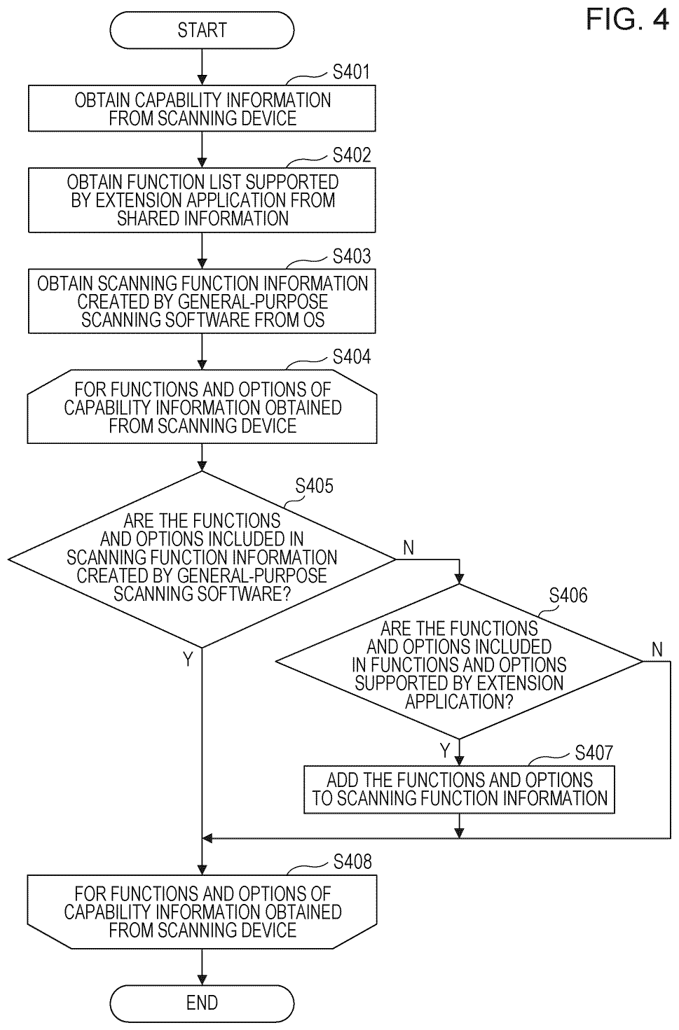

Referring next to FIG. 4, a processing procedure for the scanning-function extension unit 206 to edit the scanning function information 203 will be described. The individual steps are carried out by the CPU 111 executing the units that are read from the external storage 114 into the RAM 113.

In S401, first, the scanning-function extension unit 206 obtains capability information from the scanning device 102. The capability information includes attribute information indicating the functions that can be specified by the scanning device 102 and setting values related to the attribute information.

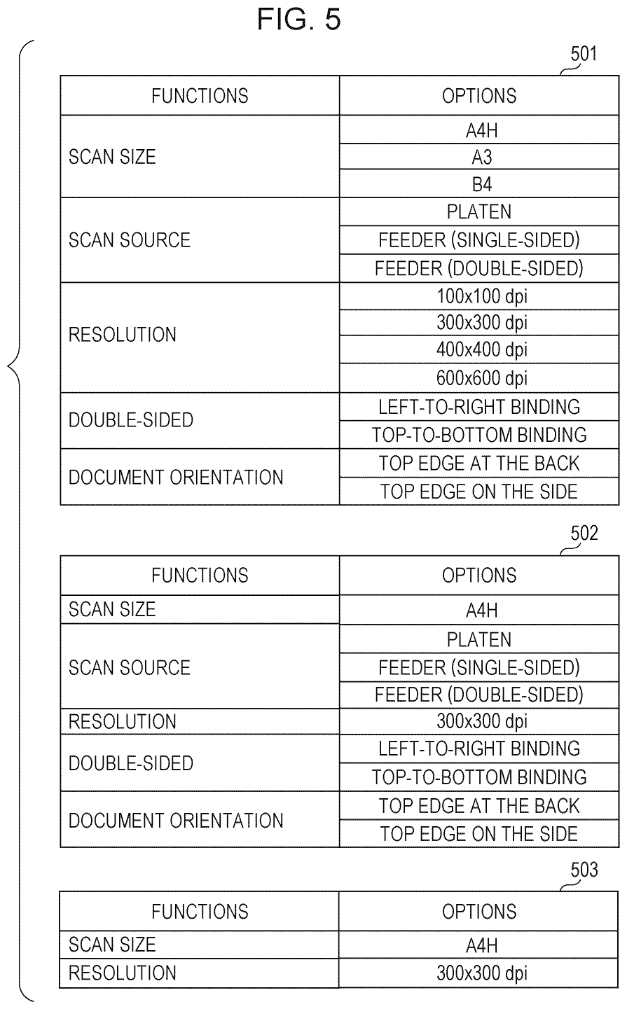

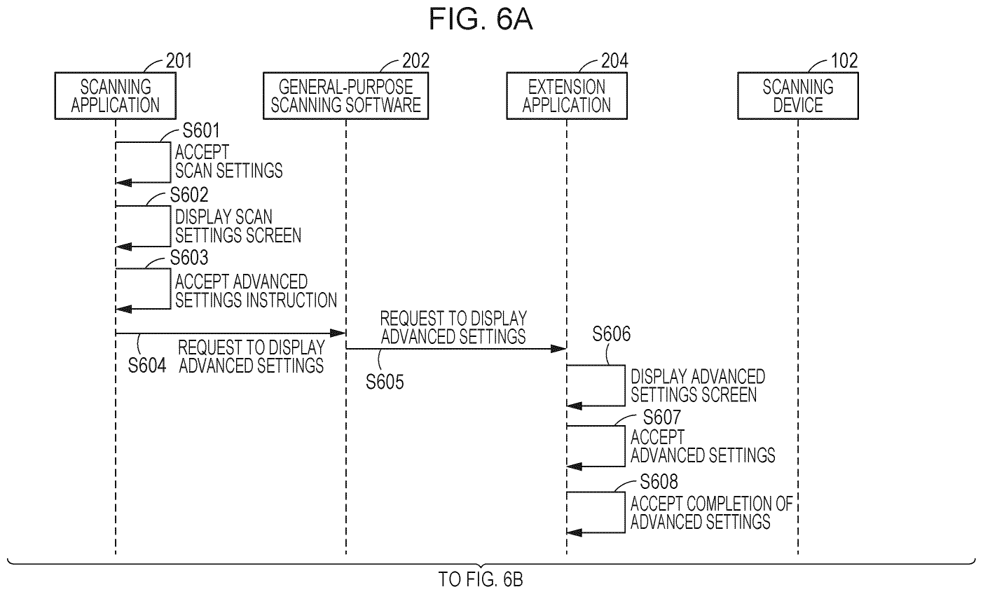

FIG. 5 illustrates capability information 501, which is an example of a list of capability information obtained from the scanning device 102, in tabular form. As shown in the capability information 501, scan size selection and other functions and settable options for the functions can be obtained from the scanning device 102.

In S402, the scanning-function extension unit 206 obtains a list of scanning functions supported by the extension application 204 from the shared information 208. The list of scanning functions supported by the extension application 204 is stored in the shared information 208 and includes all scanning functions that can be processed by the extension application 204 and their setting values.

FIG. 5 illustrates an example of extended support functions 502, which are scanning functions supported by the extension application 204. The list of scanning functions supported by the extension application 204 may be updated by updating the extension application 204.

In S403, the scanning-function extension unit 206 obtains the scanning function information 203 created by the general-purpose scanning software 202 from the OS. FIG. 5 illustrates general-purpose support functions 503, which are scanning functions supported by the general-purpose scanning software 202.

The scanning function information 203 created by the general-purpose scanning software 202 is created based on the capability information 501 that is obtained by the general-purpose scanning software 202 from the scanning device 102. The scanning function information 203 created by the general-purpose scanning software 202 includes, among the capability information obtained from the scanning device 102, only the general-purpose support functions 503, which are scanning functions supported by the general-purpose scanning software 202. For this reason, the functions of the scanning function information 203 are limited.

For example, the capability information 501 obtained from the scanning device 102 includes the scan source specification function, whereas the general-purpose scanning software 202 does not support the scan source specification function, and the scanning function information 203 does not include the scan source specification function.

By adding functions and options to the scanning function information 203 through the scanning-function extension unit 206, the extension application 204 can compensate for the functional limitations of the general-purpose scanning software 202. The scanning-function extension unit 206 can also delete unnecessary functions and options from the scanning function information 203 created by the general-purpose scanning software 202.

The following steps S404, S405, and S406 are repeated for the list of functions in the capability information obtained from the scanning device in S401. In this embodiment, the processes are repeated for the 14 options included in the capability information 501, scan size: A4H to document orientation: top edge on the side.

First, in S405, the scanning-function extension unit 207 determines whether the functions and the options in process are included in the scanning function information 203 created by the general-purpose scanning software 202. If the functions and options being processed are included in the scanning function information 203 (Yes in S405), the process returns to the beginning of the repetition loop, where the scanning-function extension unit 207 selects the next item from the functions and options of the capability information obtained from the scanning device 102 and performs S404 again. If the last item of the functions and options of the capability information obtained from the scanning device 102 is being processed, the process exits from the loop and terminates the flowchart of FIG. 4. In contrast, the function and option being processed are not included in the scanning function information 203 (No in S405), the CPU 111 proceeds to S406. In this embodiment, for example, the scan size: A4H in the capability information 501 of the scanning device 102 is included also in the general-purpose support functions 503, which is the capability information of the general-purpose scanning software 202, and therefore, it is determined in S405 as Yes. In contrast, scan source: platen in the capability information 501 is not included in the general-purpose support functions 503, and therefore, it is determined in S405 as No, and the process proceeds to S406.

Next, in S406, the scanning-function extension unit 206 determines whether the functions and options being processed are included in the functions and options supported by the extension application 204. If the functions and options being processed are included (Yes in S406), the CPU 111 proceeds to S407. In contrast, if no functions and options being processed are included (No at S406), the process returns to the first process of the repetition start loop, where the CPU 111 performs S404 again or exits from the loop and terminates the processing of the flowchart of FIG. 4 as when it is determined as Yes in S405. In this embodiment, for example, if the function being processed is “scan source: platen”, the function is included also in the extended support functions 502, which is the capability information of the extension application 204, and therefore, it is determined as Yes in S406, and the process proceeds to S407.

In S407, the scanning-function extension unit 206 adds the function and option being processed to the scanning function information 203. After completion of the process of S407, the CPU 111 performs S404 again or terminates the processing of the flowchart of FIG. 4, just as when it is determined as Yes in S405.

Thus, the scanning-function extension unit 206 adds the functions and options that are not supported by the general-purpose scanning software 202 and are supported by the scanning device 102 and the extension application 204 to the scanning function information 203. Scan capability is generated based on the scanning function information 203 edited through this processing. Furthermore, the scan-settings-screen extension unit 205 can extend functions that are not supported by the general-purpose scanning software 202 and display the advanced-settings screen illustrated in FIG. 3C by generating a display screen based on the generated scan capability.

### Scanning Sequence

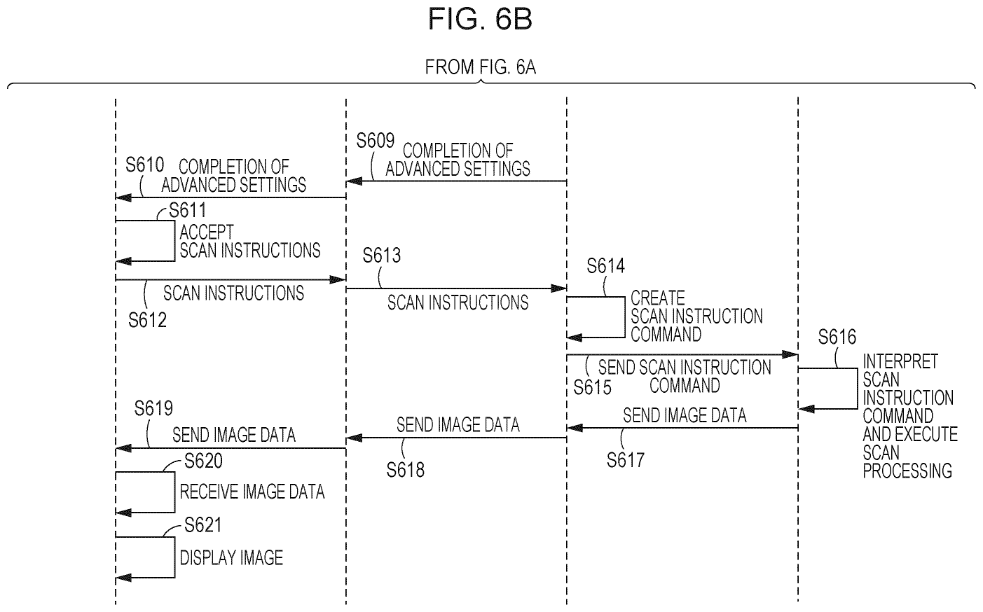

Referring next to FIGS. 6A and 6B, the scanning sequence performed by the scan application 201, the general-purpose scanning software 202, the extension application 204, and the scanning device 102 will be described. The steps other than those of the scanning device 102 in FIGS. 6A and 6B are performed by the CPU 111 reading the scan application 201, the general-purpose scanning software 202, and the extension application 204 from the external storage 114 into the RAM 113 and executing them. The steps of the scanning device 102 in FIGS. 6A and 6B are implemented by the CPU 191 of the scanning device 102 reading the codes of the computer-executable programs stored in the ROM 192 or the external storage 199 into the RAM 193 and executing them.

In S601, the scan application 201 accepts scan settings from the user.

The user can instruct the scan application 201 to configure scan settings by operating the pointing device 117 or the keyboard 118.

In S602, the scan application 201 displays the scan-settings screen illustrated in FIG. 3A on the display 119.

In S603, the scan application 201 accepts an advanced settings instruction. The user can provide the advanced settings instruction by operating the pointing device 117 or the keyboard 118 to select the control 302.

In S604, the scan application 201 requests the general-purpose scanning software 202 to display advanced settings.

In S605, the general-purpose scanning software 202 requests the extension application 204 to display the advanced settings. In the case of the configuration of FIG. 2B, the general-purpose scanning software 202 displays the advanced-settings screen of FIG. 3C, as described above.

In S606, the scan-settings-screen extension unit 205 of the extension application 204 displays the advanced-settings screen of FIG. 3C on the display 119. This is because the scan source specification function and other functions are added to the scanning function information 203 by the scanning-function extension unit 206 as illustrated in FIG. 4. The scan-settings-screen extension unit 205 displays the advanced- settings screen of FIG. 3C on the display 119 with reference to the scan capability generated based on the scanning function information 203 after the addition. In this embodiment, since the scan size supported by the extension application 204 is limited to a single type, A4H, there is no need for the user to make a selection, and it is displayed as read-only on the advanced-settings screen. Since the resolution is also limited to a single type, 300×300 dpi, it is displayed as unchangeable read-only on the advanced-settings screen. The unchangeable items may be configured not to be displayed on the advanced- settings screen.

In S607, the scan-settings-screen extension unit 205 accepts the advanced settings. In this embodiment, “scan source: feeder (double-sided)”, “binding orientation for double-sided originals: top-to-bottom binding”, and “document orientation: top edge at the back” are selected by the user, as illustrated in FIG. 3C. The accepted settings are stored in the RAM 113 by the CPU 111.

In S608, the scan-settings-screen extension unit 205 accepts completion of the advanced settings and instructs the CPU 111 to write the accepted settings into the scan settings information. The user can provide an instruction to terminate the advanced settings by operating the pointing device 117 or the keyboard 118 to select the control 306. Items that are not selected by the user, such as the resolution, may be written together when the scan settings are written to the scan settings information.

In S609, the extension application 204 sends completion of the advanced settings to the general-purpose scanning software 202.

In S610, the general-purpose scanning software 202 sends the completion of the advanced settings to the scan application 201.

In S611, the scan application 201 accepts scan instructions. The user can provide the scan instructions by selecting the control 303 with the pointing device 117 or the keyboard 118.

In S612, the scan application 201 provides the scan instructions to the general-purpose scanning software 202.

In S613, the general-purpose scanning software 202 provides the scan instructions to the extension application 204.

Next, in S614, the extension application 204 creates a scan instruction command based on the scan settings information written in S608. If in S608 items that are not selected by the user, such as resolution, are not written to the scan settings information, the extension application 204 may add the items when creating the scan instruction command in S614. Alternatively, the scanning device 102 may be operated with its default value without adding the items.

Next, in S615, the extension application 204 sends the scan instruction command to the scanning device 102 for scanning.

In S616, the scanning device 102 interprets the scan instruction command and executes a scan.

Whether the document scan source is the platen or the feeder is determined according to the control 307 for selecting a scan source described above. If the feeder is selected, whether to scan only a single side or double sides of the document is also determined according to the specification of the control 307. Next, necessary image processing according to the scan instructions is performed on the image data during execution of the scan. In this embodiment, the scan settings illustrated in FIG. 3C have been configured, and the image data obtained by the scan is rotated so as to be positioned in correct orientation on the PC according to the specification of the binding operation for double-sided originals (309) and the document orientation (311).

In S617, the scanning device 102 sends the generated image data to the extension application 204.

In S618, the extension application 204 sends the received image data to the general-purpose scanning software 202.

In S619, the general-purpose scanning software 202 sends the received image data to the scan application 201.

In S620, the scan application 201 receives the image data.

In S621, the scan application 201 displays the received image data.

### Scan Processing (Extension Application

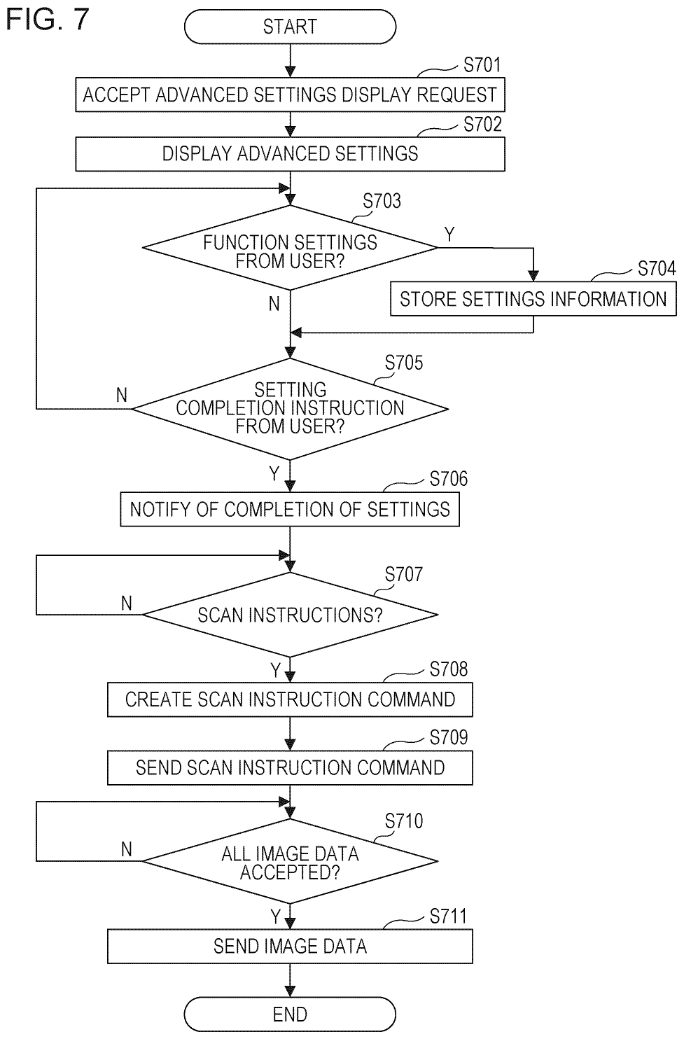

Next, the procedure of scan processing executed by the extension application 204 will be described with reference to FIG. 7. The steps are implemented by the CPU 111 executing the units read from the external storage 114 into the RAM 113.

The following steps S701 to S706 correspond to the processes of S606 to S608 in the sequence of FIG. 6A, and steps S707 to S711 correspond to the processes of S614 to S617 in FIG. 6B.

### Advanced Settings

In S701, the extension application 204 accepts a request to display advanced settings from the general-purpose scanning software 202.

In S702, the scan-settings-screen extension unit 205 of the extension application 204 displays the advanced-settings screen of FIG. 3C on the display 119. This is because, the document scan source specification function and so on are added to the scanning function information 203 by the scanning-function extension unit 206 as illustrated in FIG. 4. The scan-settings-screen extension unit 205 displays the advanced- settings screen of FIG. 3C on the display 119 with reference to the scan capability generated based on the scanning function information 203 after the addition.

In S703, the scan-settings-screen extension unit 205 determines whether any functions have been configured by the user. If some functions have been configured by the user (Yes in S703), the CPU 111 proceeds to S704; otherwise (No in S703), the process proceeds to S705.

In S704, the extension application 204 accepts the advanced settings specified by the user. The accepted settings are stored in the RAM 113 by the CPU 111. The process proceeds to S705.

Next, in S705, the scan-settings-screen extension unit 205 determines whether a setting completion instruction has been provided by the user. If a setting completion instruction has been provided (Yes in S705), the CPU 111 proceeds to S706; otherwise (No in S705), the process returns to S703, where function settings from the user are waited for.

In S706, since completion of the advanced settings has been accepted, the accepted settings are written to the scan settings information. Then, the extension application 204 sends the completion of the advanced settings to the general-purpose scanning software 202.

### Scan Instructions

Next, in S707, the extension application 204 determines whether scan instructions have been provided by the general-purpose scanning software 202. If scan instructions have been provided (Yes in S707), the CPU 111 proceeds to S708; otherwise (No in S707) the CPU 111 waits in S707.

In S708, the extension application 204 creates a scan instruction command based on the scan settings information written in S706. An example of how to create the scan instruction command is a method in which a standard protocol command is extended. An example of the extension method is to specify a dedicated command in the extended area of the standard protocol command. Other examples include a method in which a proprietary protocol command is added to the tail end of a standard protocol command and a method in which the extension application 204 overwrites the standard protocol command with a proprietary command system.

If the instructions are provided by the extension application 204, instructions and communication may be carried out using a vendor's proprietary protocol without reference to the standard protocol.

In S709, the extension application 204 sends the scan instruction command to the scanning device 102.

In S710, the extension application 204 determines whether all image data has been accepted from the scanning device 102. If all image data has been received (Yes in S710), the CPU 111 proceeds to S711; otherwise (No in S710), then, in S710, the CPU 111 waits, with the image data accepted.

In S711, the extension application 204 sends the received image data to the general-purpose scanning software 202.

### Scan Processing (Scanning Device)

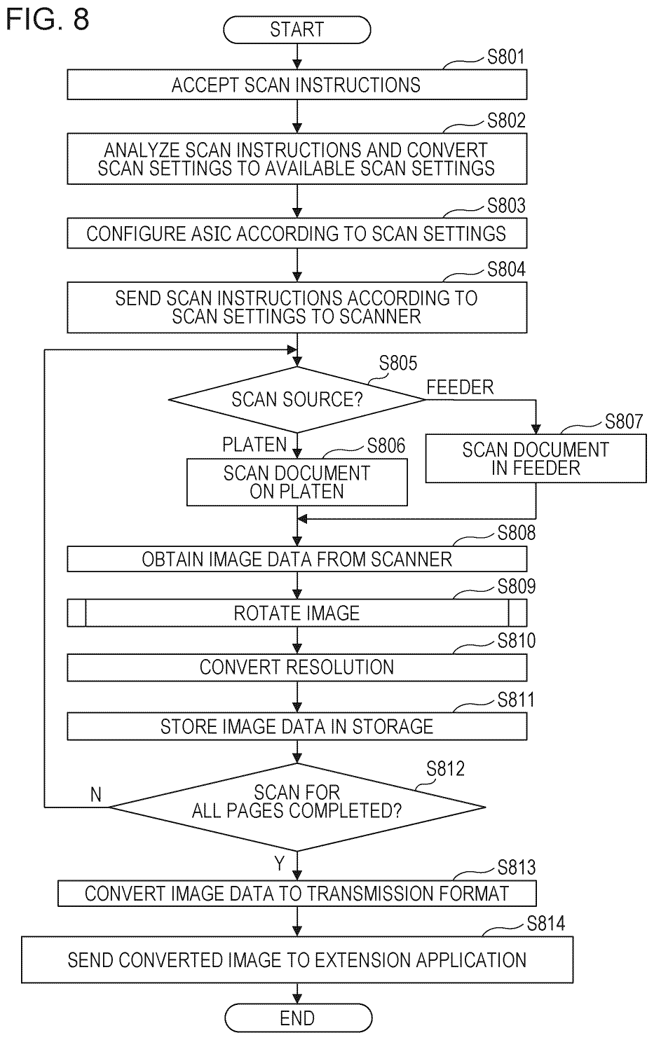

Next, the procedure of scan processing executed by the scanning device 102 will be described with reference to FIG. 8. The steps are implemented by the CPU 191 executing the units read from the external storage 199 into the RAM 193.

The following steps S801 to S814 correspond to the process of S616 in the sequence of FIG. 6B.

In S801, the CPU 191 accepts scan instructions sent from the extension application 204.

In S802, the CPU 191 analyzes the scan instruction command accepted in S615 of FIG. 6B and converts the scan settings to scan settings with which the scanning device 102 can perform scan processing. In this embodiment, the scan settings are “scan source: feeder (double-sided)”, “scan size: A4H”, “resolution: 300×300 dpi”, “binding orientation for double-sided originals: top-to-bottom binding”, and “document orientation: top edge at the back”.

In S803, the CPU 191 determines an application specific integrated circuit (ASIC) for the image processing unit 190 to be used to execute the scan according to the scan settings converted in step S802 and configures the ASIC.

In S804, the CPU 191 sends scan instructions according to the scan settings to the scanner 195. In this embodiment, the CPU 191 sends instructions to perform double-sided scanning of A4H-sized paper from the feeder.

In S805, the CPU 191 switches between the next processes according to the specified scan source. If the platen is specified as the scan source, the process proceeds to S806. If the feeder (single-sided or double-sided) is specified, the process proceeds to S807.

In S806, the CPU 191 scans the document on the platen with the scanner 195 and proceeds to S808.

In S807, the CPU 191 conveys the document to the feeder, scans the conveyed document with the scanner 195, and proceeds to S808.

In S808, the CPU 191 obtains image data generated by scanning the document with the scanner 195 from the scanner 195.

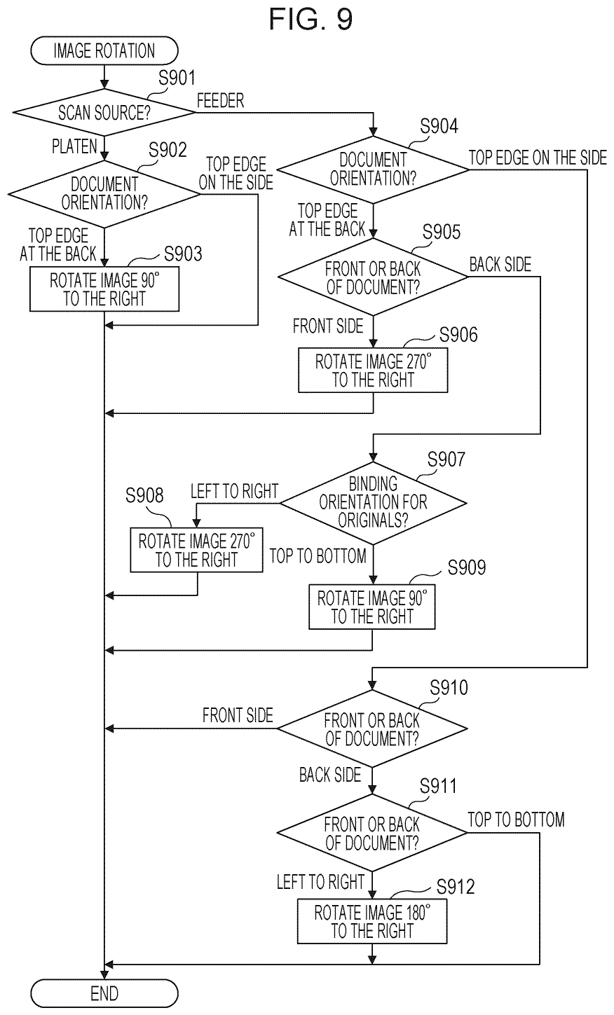

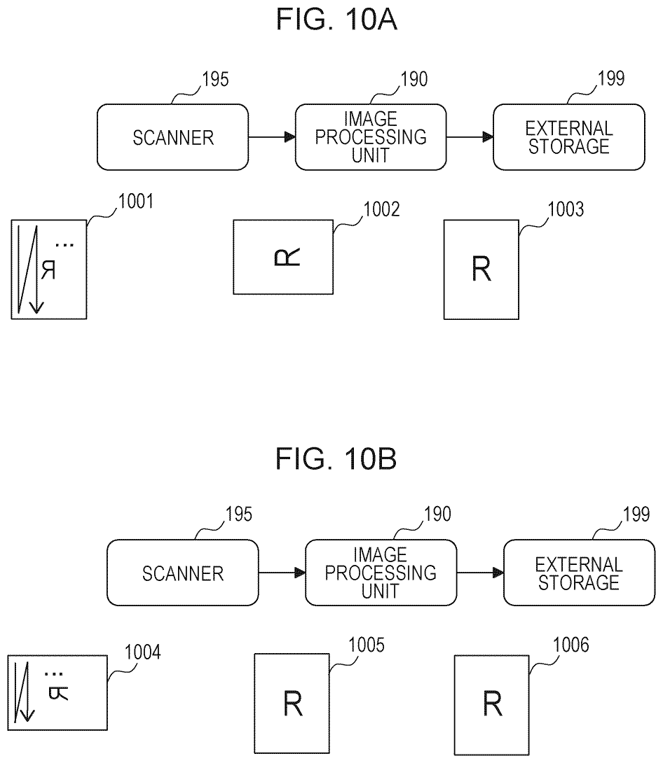

In S809, the CPU 191 and the image processing unit 190 rotate the received image data according to the specified scan source, the binding orientation for double-sided originals, and the document orientation. The details of the processing will be described with reference to FIG. 9 and FIGS. 10A and 10B.

In S810, the CPU 191 converts the resolution of the rotated image data to 300×300 dpi.

In S811, the CPU 191 stores the image data in the external storage 199.

In S812, the CPU 191 determines whether the scan processing for all pages (including the reverse side in the case of a double-sided setting) has been completed. If the CPU 191 determines that the scan processing has not been completed (No in S812), the CPU 191 returns to S805 and executes the scan processing of the next page. If the CPU 191 determines that the scan processing has been completed (Yes in S812), the CPU 191 proceeds to S813.

In S813, the CPU 191 and the image processing unit 190 convert the image data stored in S811 according to the transmitted format settings accepted in S801. In this embodiment, since the transmitted format is not included in the scan instructions accepted from the extension application 204, the image data is converted to the default joint photographic experts group (JPEG) of the scanning device 102. However, the transmitted format for conversion is not limited to this; any format that can be supported by the information processing apparatus is acceptable.

In S814, the converted image data is sent to the extension application 204, and all the processes end.

### Image Rotation Process: Scanning Device

The image rotation process, which is a characteristic operation in this embodiment, will be described with reference to FIG. 9 and FIGS. 10A and 10B. FIG. 9 illustrates the details of the image rotation process performed in the earlier step S809.

First, in S901, the CPU 191 switches between the next processes based on the specified scan source. If the specified scan source is the platen, the CPU 191 proceeds to S902; whereas if the specified scan source is the feeder, the CPU 191 proceeds to S904.

In S902, the CPU 191 switches between the next processes based on the specified document orientation. If the specified document orientation is the top edge at the back, the CPU 191 proceeds to S903.

In S903, the image data received in the earlier step S808 is rotated to the right at 90 degrees by the image processing unit 190, and this processing ends.

In contrast, if the specified document orientation is the top edge on the side, this processing ends without rotating the image data.

### —Rotation Processing for Document Placed on Platen—

The rotation processing for the document placed on the platen is illustrated in detail in FIGS. 10A and 10B. FIG. 10A illustrates the rotation processing when a document is placed on the platen with the top edge facing up. FIG. 10B is a diagram illustrating the rotation processing when the document is placed on the platen with the top edge on the side.

Reference sign 1001 in FIG. 10A denotes a document placed on the platen with the printed side facing downward. The reversal of the letter R indicates that the printed side is facing downward.

The document 1001 is scanned by the scanner 195 (platen) as indicated by the arrow and is recorded in the RAM 193 as image data 1002. Since the image data 1002 obtained from the scanner 195 (platen) is oriented to the left (9 o'clock orientation), the image data 1002 is rotated by the image processing unit 190 to the right at 90 degrees to reach the 0 o'clock orientation. The image 1003 after rotation is oriented correctly, with the top edge of the document facing up.

Reference sign 1004 in FIG. 10B is a document placed on the platen, which differs from the document 1001 in that the orientation is changed from the top edge at the back to the top edge on the side. When the document is placed with the top edge oriented to the side, the image data scanned by the scanner 195 (platen) is oriented at the 0 o'clock position, as shown in image 1005. Since the image has already been oriented to the 0'oclock position at that time, the rotation processing by the image processing unit 190 is not needed, and another image processing (in this case, resolution conversion to 300×300 dpi) is performed to generate image data 1006.

Referring back to FIG. 9, a description will be provided from step S904 when the scan source specified in S901 is the feeder (single-sided or double-sided).

In S904, the next process to be executed is switched according to the specified document orientation. If the specified document orientation is “top edge at the back”, the CPU 191 proceeds to S905, and if “top edge on the side”, the CPU 191 proceeds to S910.

In S905, the next process is switched depending on whether the current page being processed is the front or back side of the document. If the current page is the front side, then the CPU 191 proceeds to S906; whereas if it is the back side, the CPU 191 proceeds to S907.

In S906, the CPU 191 has the image processing unit 190 rotate the image data received in earlier step S808 270 degrees to the right and terminates this processing.

In contrast, in S907 following the case where the current page is the back side of the document, the next process is switched according to the setting of the document binding orientation. If the document binding orientation setting is “left to right”, the CPU 191 proceeds to S908, and if it is “top to bottom”, the CPU 191 proceeds to S909.

In S908, the CPU 191 rotates the image data received in the earlier step S808 270 degrees to the right and terminates this processing.

In S909, the CPU 191 rotates the image data 90 degrees to the right and terminates this processing.

### —Rotation Processing for Document Placed in Feeder With Top Edge at the Back—

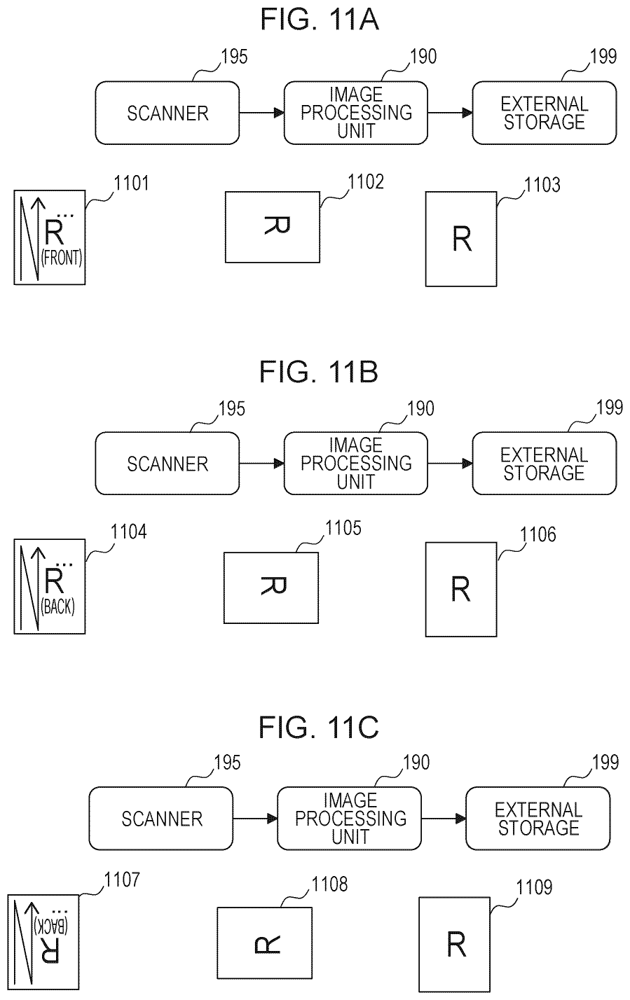

The details of rotation processing performed for the document placed in the feeder with the top edge at the back are illustrated in FIGS. 11A to 11C.

FIG. 11A is a diagram illustrating the rotation processing for the front side of the document placed in the feeder with the top edge at the back.

FIG. 11B is a diagram illustrating the rotation processing for the back side of the left-to-right bound document placed in the feeder with the top edge at the back.

FIG. 11C is a diagram illustrating the rotation processing for the back side of the top-to-bottom bound document placed in the feeder with the top edge at the back.

A document 1101 in FIG. 11A is a document (front side) placed in the feeder, with the top edge at the back, and the printing side facing up. The document 1101 is scanned by the scanner 195 (feeder) from the bottom up as indicated by the arrow and is recorded in the RAM 193 as image data 1102. The image data 1102 obtained by the scanner 195 (feeder) is oriented to the right (the 3 o'clock position). For this reason, to orient the image data 1102 to the 0 o'clock position, the image data 1102 needs to be rotated 270 degrees to the right by the image processing unit 190. The image after the rotation is image data 1103, which is orientated to the correct position at which the top edge of the document faces up.

A document 1104 in FIG. 11B corresponds to the back side of the left-to-right bound document 1101. FIG. 11B illustrates starting the scanning of the back side of the document 1104 obtained by scanning the document 1101 in the feeder and reversing it. The document 1104 is scanned by the scanner 195 (feeder) from the bottom up as indicated by the arrow and is recorded in the RAM 193 as image data 1105. The image data 1105 obtained by the scanner 195 (feeder) is oriented to the right (the 3 o'clock position). For this reason, to orient the image data 1105 to the 0 o'clock position, the image data 1105 needs to be rotated 270 degrees to the right by the image processing unit 190. The image after the rotation is image data 1106, which is orientated to the correct position at which the top edge of the document faces up.

A document 1107 in FIG. 11C corresponds to the back side of the top-to-bottom bound document 1101. FIG. 11C illustrates starting the scanning of the back side of the document 1107 obtained by scanning the document 1101 in the feeder and reversing it. The document 1107 is scanned by the scanner 195 (feeder) from the bottom up as indicated by the arrow and is recorded in the RAM 193 as image data 1108. The image data 1108 obtained by the scanner 195 (feeder) is oriented to the right (the 9 o'clock position). For this reason, to orient the image data 1108 to the 0 o'clock position, the image data 1108 needs to be rotated 90 degrees to the right by the image processing unit 190. The image after the rotation is image data 1109, which is orientated to the correct position at which the top edge of the document faces up.

Referring back to FIG. 9 again, a description will be provided from step S910 when the document orientation specified in S904 is the top edge on the side.

In S910, the next process is switched depending on whether the current page being processed is the front or back side of the document. If the current page is the front side, the CPU 191 does not perform rotation processing and terminates this processing; whereas if it is the back side, the CPU 191 proceeds to S911.

In S911, the next process is switched according to the setting of the document binding orientation. If the document binding orientation setting is “left to right”, the CPU 191 proceeds to S912, and if it is “top to bottom”, the CPU 191 does not perform rotation processing and terminates this processing.

In S912, the CPU 191 rotates the image data received in the earlier step S808 180 degrees to the right and terminates this processing.

### —Rotation Processing for Document Placed in Feeder With Top Edge on the Side—

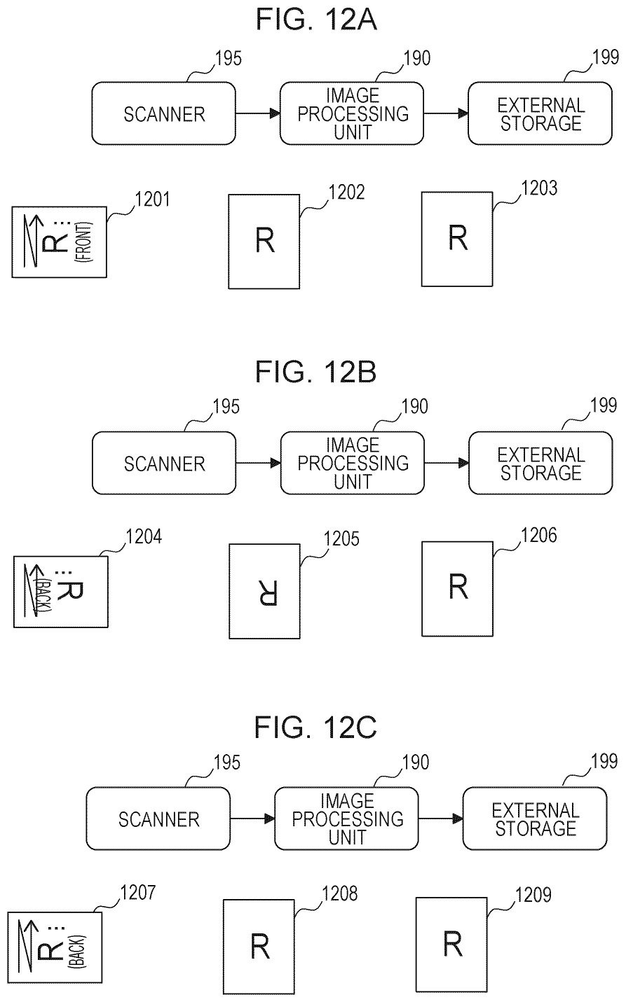

The details of rotation processing for the document placed in the feeder with the document orientation top edge on the side are illustrated in FIGS. 12A to 12C.

FIG. 12A illustrates rotation processing for the front side of the document placed in the feeder with the top edge on the side.

FIG. 12B is a diagram illustrating rotation processing for the back side of a left-to-right bound document placed in the feeder with the top edge oriented to the side.

FIG. 12C is a diagram illustrating rotation processing for the back side of a top-to-bottom bound document placed in the feeder with the top edge oriented to the back.

A document 1201 in FIG. 12A is a document (front side) placed in the feeder, with the top edge on the side, and the printing side facing up. The document 1201 is scanned by the scanner 195 (feeder) from the bottom up as indicated by the arrow and is recorded in the RAM 193 as image data 1202. The image data 1202 obtained by the scanner 195 (feeder) is oriented at the 0 o'clock position). Since the image has already been oriented to the O'oclock position at that time, the rotation processing by the image processing unit 190 is not needed, and another image processing (in this case, resolution conversion to 300×300 dpi) is performed to generate image data 1203.

A document 1204 in FIG. 12B corresponds to the back side of the left-to-right bound document 1201. FIG. 12B illustrates starting the scanning of the back side of the document 1204 obtained by scanning the document 1201 in the feeder and reversing it. The document 1204 is scanned by the scanner 195 (feeder) from the bottom up as indicated by the arrow and is recorded in the RAM 193 as image data 1205. The image data 1205 obtained by the scanner 195 (feeder) is oriented downward (the 6 o'clock position). For this reason, to orient the image data 1205 to the 0 o'clock position, the image data 1205 needs to be rotated 180 degrees to the right by the image processing unit 190. The image after the rotation is image data 1206, which is orientated to the correct position at which the top edge of the document faces up.

A document 1207 in FIG. 12C corresponds to the back side of the top-to-bottom bound document 1201. FIG. 12C illustrates starting the scanning of the back side of the document 1207 obtained by scanning the document 1201 in the feeder and reversing it. The document 1207 is scanned by the scanner 195 (feeder) from the bottom up as indicated by the arrow and is recorded in the RAM 193 as image data 1208. The image data 1208 obtained by the scanner 195 (feeder) is oriented to the o'clock position. Since the image has already been oriented to the O'oclock position at that time, the rotation processing by the image processing unit 190 is not needed, and another image processing (in this case, resolution conversion to 300×300 dpi) is performed to generate image data 1209.

### Other Examples of Scan-Settings Screen

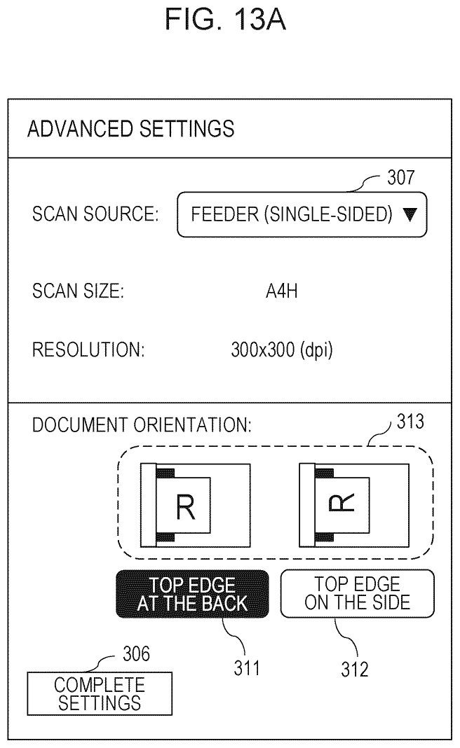

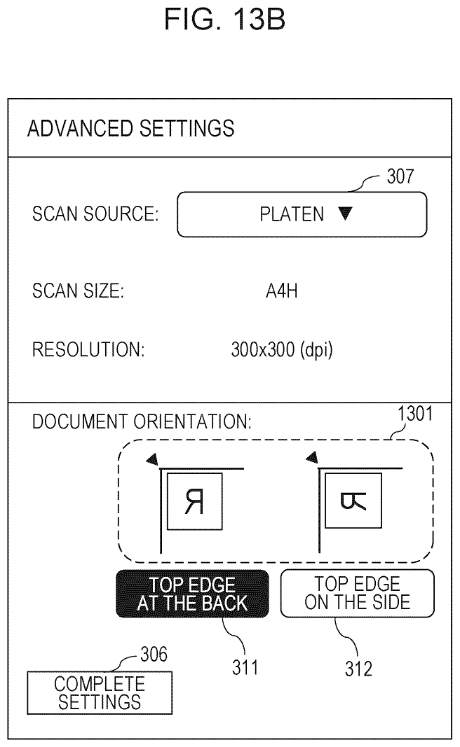

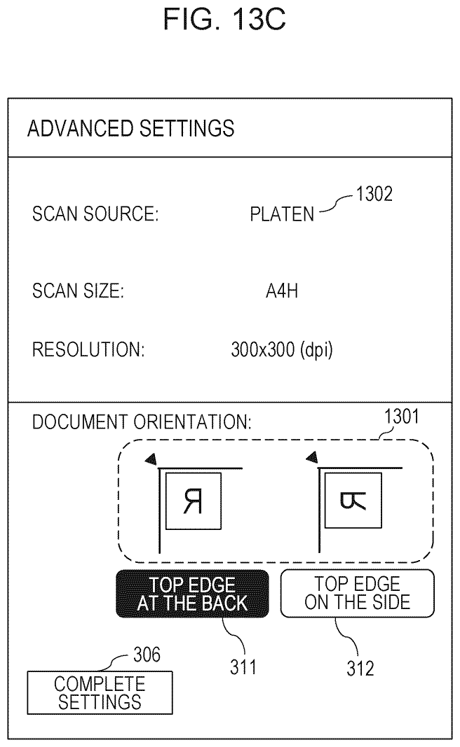

The aforementioned FIG. 3C illustrates an example in which “feeder (double-sided)” is specified as the scan source, whereas FIGS. 13A to 13C illustrate screen examples of other settings and display examples of a screen corresponding to the capability response of the scanning device 102.

FIG. 13A illustrates an advanced-settings screen when “feeder (single-sided)” is specified as the scan source. The difference from FIG. 3C is that “binding orientation for double-sided originals” is not displayed. This is because “single-sided scan settings” is selected in the control 307, and therefore, settings for double-sided scan are not required.

FIG. 13B illustrates an advanced-settings screen when “platen” is specified as the scan source. The difference from FIG. 3C is that “binding orientation for double- sided originals” is not displayed and that a user guide 1301 for setting document orientation is displayed. The reason why the specification for “binding orientation for double-sided originals” is not displayed is that a single-sided scan is performed when the platen is selected, making double-sided scan settings unnecessary. The user guide 1301 for setting the document orientation is an example in which the document is placed on the platen according to the specified scan source, unlike the user guide 313 in FIG. 3C. The reversed letter R represents the document being placed with the printing side facing downward.

FIG. 13C illustrates a screen example in which the specification for “scan source” is limited to the platen in the capability information obtained from the scanning device 102. In this case, the specification for “scan source” is fixed to the platen as in a control 1302, unlike the control 307 in FIG. 3C.

As has been described above, in this embodiment, the scan-settings-screen extension unit 205 of the extension application 204 corrects the scanning function information 203 based on the capability information from the general-purpose scanning software 202, the extension application 204, and the scanning device 102. When an advanced-settings screen is requested from the user, a settings screen is displayed based on the scan capability generated from the scanning function information 203, allowing the user to specify the document scan source. Then, upon receiving scan instructions that reflect the specified document scan source, the scanning device 102 scans the document from the scanner corresponding to the specification and performs rotation processing on the obtained image data as necessary. Through the above series of processes, the scanning device 102 can implement the document scan source specification function, allowing for providing the document scan source specification function to the user.

Although this embodiment has been described using the advanced-settings screen illustrated in FIG. 3C with the configuration of FIG. 2B, the present disclosure is not limited to the embodiment. For example, when in S604 an advanced settings display request is provided to the general-purpose scanning software 202, the general-purpose scanning software 202 may display the advanced-settings screen illustrated in FIG. 3B. Next, after completion of the advanced settings in FIG. 3B, the general-purpose scanning software 202 requests the extension application 204 to display an additional advanced- settings screen. Next, the extension application 204 may additionally display an advanced-settings screen in which the document scan source can be specified.

Although the scan instructions to the extension application 204 are provided from the general-purpose scanning software 202, this is illustrative only. Other examples include a method in which the instructions are provided from the scan application 201 to the extension application 204 and a configuration in which a control for scan instructions is disposed on the advanced-settings screen so that the user can directly provide instructions to the extension application 204. The image data may be directly passed from the extension application 204 to the scan application 201 not via the general- purpose scanning software 202 or may be passed from the scanning device 102 to the scan application 201. The accepted image data may be stored in the external storage 114, with only the file path information of the storage being passed along.

In this embodiment, when multiple pieces of image data are involved, all the image data is accepted and then passed along at once. Alternatively, transmitted image data may be passed along at any time.

### Second Embodiment

A second embodiment of the present disclosure will be described hereinbelow. In the first embodiment, the scan processing has been described on the assumption that a document is correctly placed on the platen or the feeder specified as the scan source. In the second embodiment, a method will be described in which, if a document may be placed in a location other than the specified scan source, a prompt for the user to check the document placement status is displayed on the advanced-settings screen. Only the difference from the first embodiment will be described hereinbelow.

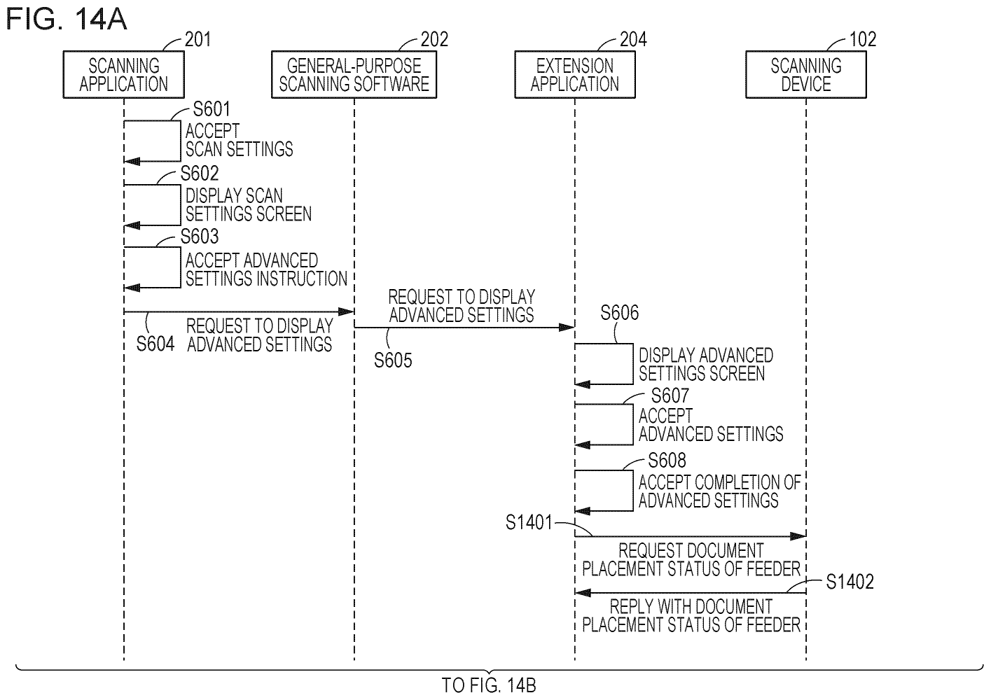

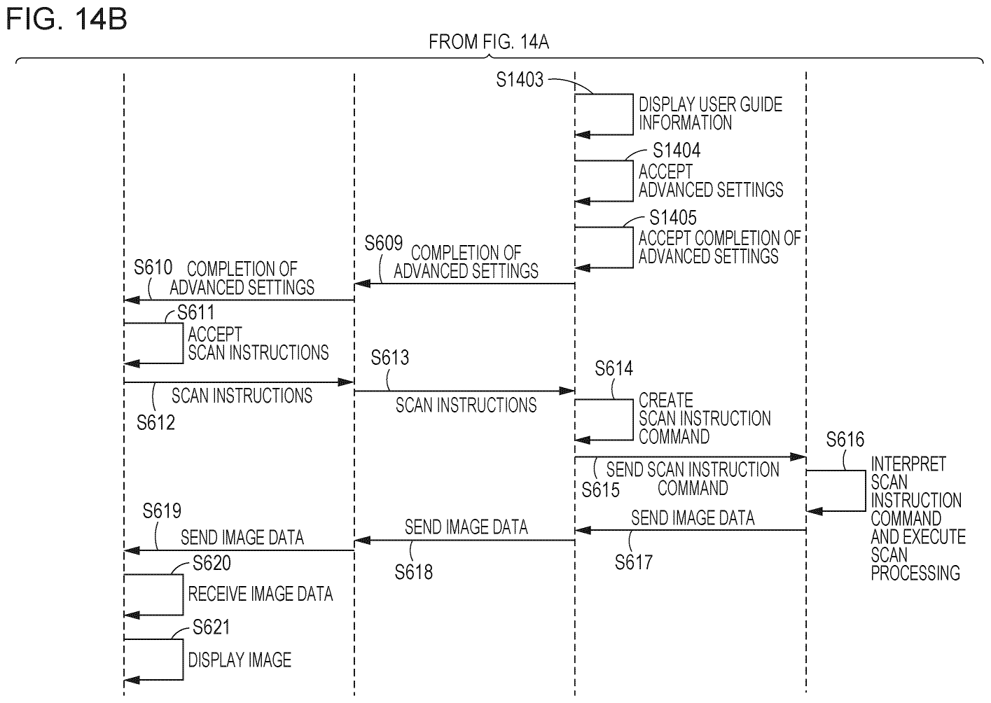

Referring to FIGS. 14A and 14B, the sequence performed by the scan application 201, the general-purpose scanning software 202, the extension application 204, and the scanning device 102 after the scan application 201 accepted scan settings will be described. The steps other than those of the scanning device 102 in FIGS. 14A and 14B are performed by the CPU 111 reading the scan application 201, the general-purpose scanning software 202, and the extension application 204 from the external storage 114 into the RAM 113 and executing them. The steps of the scanning device 102 in FIGS. 14A and 14B are implemented by the CPU 191 of the scanning device 102 reading the codes of the computer-executable programs stored in the ROM 192 or the external storage 199 into the RAM 193 and executing them.

Here, the user specified the platen as the scan source as in FIG. 13B although the user placed a document in the feeder.

The processing will be described from the process next to S608 in which the scan-settings-screen extension unit 205 has accepted completion of the advanced settings.

In S1401, the extension application 204 requests the scanning device 102 to send the document placement status of the feeder. The feeder is equipped with a document load sensor (not illustrated), which detects whether a document is placed in the feeder.

In S1402, the scanning device 102 responds to the extension application 204 whether a document is placed in the feeder based on the detection result of the document load sensor.

In S1403, the scan-settings-screen extension unit 205 displays a guide that prompts the user to check the specified scan source on the extension application 204 based on the setting of the scan source determined in S608 and the determination of whether a document is placed in the feeder, obtained from the scanning device 102.

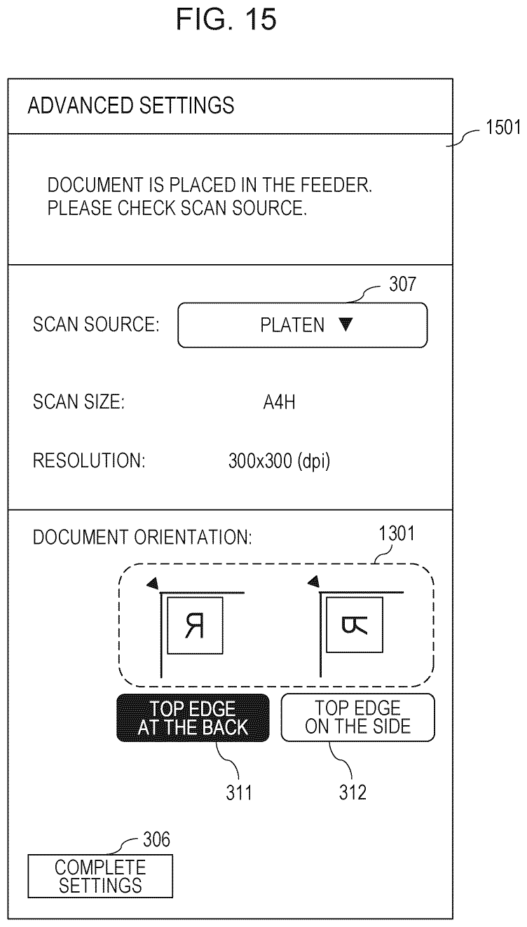

A guide 1501 in FIG. 15 is an example of the display. In this example, the user placed a document in the feeder but selects the platen as the scan source in the control 307. For this reason, the scan-settings-screen extension unit 205 displays a message to check whether the specified scan source is correct in the guide 1501.

In S1404, the scan-settings-screen extension unit 205 accepts advanced settings again.

In S1405, the scan-settings-screen extension unit 205 accepts completion of advanced settings. Since the steps following S609 are the same as those described in the first embodiment, the description will be omitted here.

### Scan Processing (Extension Application)

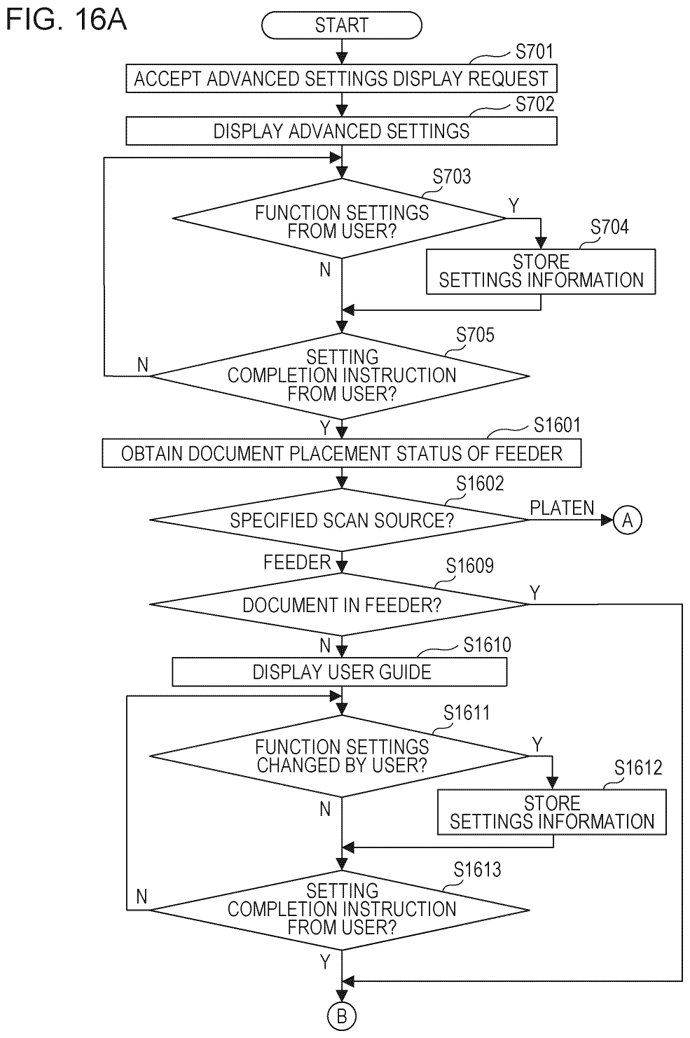

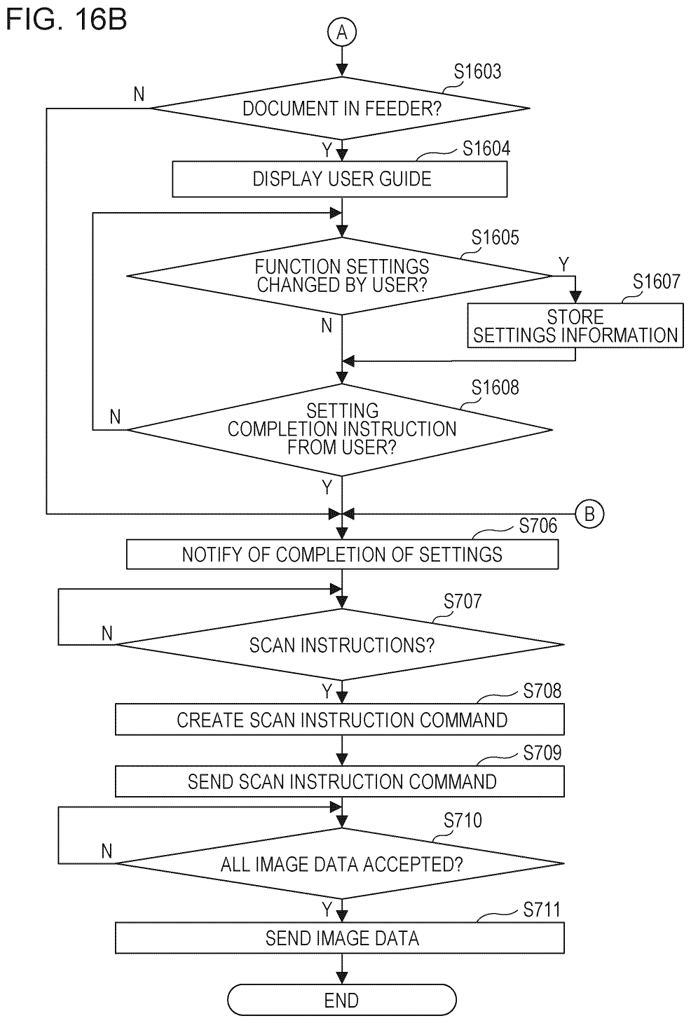

Next, the procedure of scan processing executed by the extension application 204 will be described with reference to FIGS. 16A and 16B. The steps are implemented by the CPU 111 executing the units read from the external storage 114 into the RAM 113.

Since steps S701 to S705 are the same as those described in the first embodiment, the processes from step S1601, which are characteristic operations of this embodiment, after S705 in which the extension application 204 accepts a setting completion instruction from the user, will be described.

In S1601, the extension application 204 obtains the document placement status of the feeder from the scanning device 102.

In S1602, the CPU 111 switches between the following processes according to the scan source specified by the user in the control 307. If the platen is specified, the CPU 111 proceeds to S1603; whereas if the feeder is specified, the CPU 111 proceeds to S1609.

In S1603, the CPU 111 determines whether a document is placed in the feeder based on the document placement status of the feeder obtained in S1601. If a document is placed in the feeder (Yes in S1603), the CPU 111 proceeds to S1604; otherwise (No in S1603), the CPU 111 determines that a document is placed on the platen, and the CPU 111 proceeds to S706 without displaying a guide for the user.

In S1604, the CPU 111 displays a message to check whether the specified scan source is correct, as illustrated in FIG. 15, on the extension application 204. At that time, the CPU 111 waits for a user operation on the advanced-settings screen so that the user can change the specified scan source.

In S1605, the scan-settings-screen extension unit 205 determines whether function settings have been changed by the user. If function settings have been changed (Yes in S160), the CPU 111 proceeds to S1607; whereas if they have not been changed (No in S1605), the CPU 111 proceeds to S1608.

In S1607, the CPU 111 accepts the advanced settings performed by the user, stores the settings in the RAM 113, and proceeds to S1608.

In S1608, the scan-settings-screen extension unit 205 determines whether a setting completion instruction has been provided from the user. If a setting completion instruction has been provided (Yes in S1608), the CPU 111 accepts completion of the advanced settings, writes the accepted settings in the scan settings information, and proceeds to S706. If no setting completion instruction has been provided (No in S1608), the CPU 111 returns to S1605 and determines whether function settings have been given from the user again.

If in S1602 the CPU 111 determines that the specified scan source is the feeder, the CPU 111 proceeds to S1609 and determines whether a document is placed in the feeder based on the document placement status of the feeder, obtained in S1601. If no document is placed in the feeder (No in S1609), the CPU 111 proceeds to S1610; whereas if a document is placed in the feeder (Yes in S1609), the CPU 111 determines that the specified scan source is correct and proceeds to the scan processing in S706 and the subsequent processes.

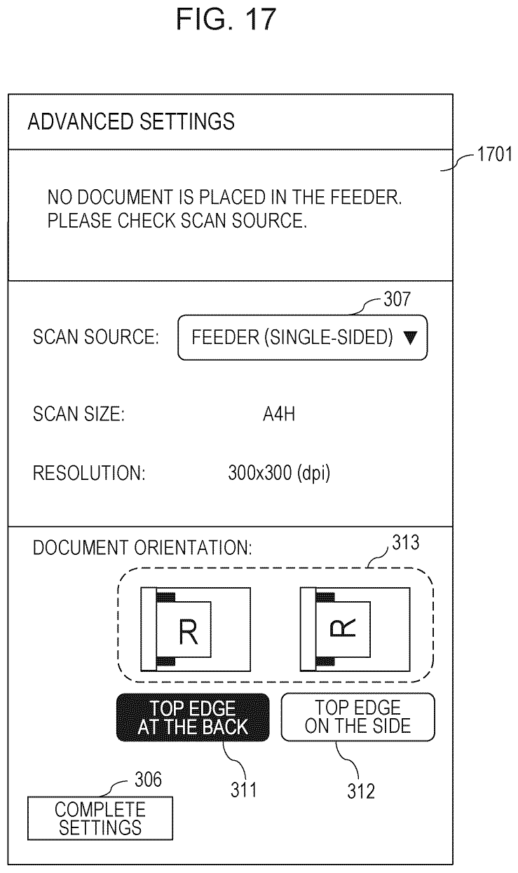

In S1610, the CPU 111 displays a message to check whether the specified scan source is correct on the extension application 204. An example is displayed in a guide 1701 in FIG. 17. This is because, the document placement status of the feeder in S1601 is No, but the feeder is specified as the scan source in the control 307. The scan-settings-screen extension unit 205 displays a message to check whether the specified scan source, which is the document placement location, is correctly set to the feeder.

Next in S1611, the scan-settings-screen extension unit 205 determines whether the function settings have been changed by the user. If the function settings have been changed (Yes in S1611), the CPU 111 proceeds to S1612; whereas if they have not been changed (No in S1609), the CPU 111 process to S1613.

In S1612, the CPU 111 accepts the advanced settings, stores the accepted settings in the RAM 113, and proceeds to S1613.

Next in S1613, the scan-settings-screen extension unit 205 determines whether a setting completion instruction has been provided from the user. If a setting completion instruction has been provided (Yes in S1613), the CPU 111 writes the accepted settings in the scan settings information and proceeds to S706. If no setting completion instruction has been provided (No in S1613), the CPU 111 returns to S1611 and determines again whether function settings have been given from the user.

This embodiment illustrates a method in which it is determined whether the scan source that is specified by the user on the advanced-settings screen is correct using the detection result of the document load sensor provided at the feeder, and a prompt to confirm whether the scan source is correct is provided. Although the document load sensor is provided at the feeder, a similar sensor may be provided also at the platen, and the display may be provided according to the detection result of the sensor of the platen or both of the sensors of the feeder and the platen.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-052421, filed Mar. 27, 2024, which is hereby incorporated by reference herein in its entirety.

What is claimed is:

1. A computer-readable storage medium that stores a program for supporting general-purpose scanning software that is commonly available for use with a plurality of image processing devices, the program causing an information processing apparatus to execute a method comprising:
displaying a screen on a display of the information processing apparatus, the screen is used to set either a platen or a feeder as a placement location for a document to be scanned; and
transmitting an instruction to scan the document to an image processing device based on the placement location specified on the screen.

2. The storage medium according to claim 1, wherein it is set on the screen whether to execute a single-sided scan in which only a first side of a document conveyed from the feeder is scanned and a double-sided scan in which the first side and a second side of the document conveyed from the feeder are scanned.

3. The storage medium according to claim 2, wherein, if it is set to execute the double-sided scan, either setting of left-to-right binding or setting of top-to-bottom binding is accepted as a document binding orientation.

4. The storage medium according to claim 1, wherein the display of the information processing apparatus further displays an option that accepts an orientation setting of the placed document.

5. The storage medium according to claim 1, wherein the application program causes the information processing apparatus to further execute:
obtaining a placement status of the document on the platen and a placement status of the document in the feeder; and
presenting, when it is determined that the document is not placed based on the placement status obtained by the obtaining, information for a user to use in determining whether setting of the placement location is correct on the display of the information processing apparatus.

6. The storage medium according to claim 1, wherein in the transmitting, the instruction to scan the document is transmitted to the image processing device by extending a standard protocol command.

7. The storage medium according to claim 1, wherein in the transmitting, the instruction to scan the document is transmitted to the image processing device by adding a proprietary protocol command to a standard protocol command.

8. The storage medium according to claim 1, wherein in the displaying, the screen is displayed based on capability information of the image processing device.

9. A method for supporting general-purpose scanning software that is commonly available for use with a plurality of image processing devices, the method comprising:
displaying a screen on a display of an information processing apparatus by executing an application program, the screen is used to set either a platen or a feeder as a placement location for a document to be scanned; and
transmitting an instruction to scan the document to an image processing device based on the placement location specified on the screen.

10. An information processing apparatus capable of executing general-purpose scanning software that is commonly available for use with a plurality of image processing devices, comprising:
at least one memory storing a program; and
at least one processor that executes the stored program, which cause the at least one processor to:
display, by executing a program for supporting the general-purpose scanning software, a screen on a display of the information processing apparatus by executing an application program, the screen is used to set either a platen or a feeder as a placement location for a document to be scanned; and
transmit an instruction to scan the document to an image processing device based on the placement location specified on the screen.
